(19) United States
(12) Patent Application Publication
(10) Pub. No.: US 2017/0327646 A1
(43) Pub. Date: Nov. 16, 2017

(54) SULFONE POLYMER COMPOSITION, PREPARATION METHOD THEREOF AND THE THERMOPLASTIC MOLDING COMPOSITION THEREFROM

(71) Applicant: KINGFA SCI. & TECH. CO., LTD., Guangzhou (CN)

(72) Inventors: Jingqi DAI, Guangzhou (CN); Hongjun GAO, Guangzhou (CN); Haobin WU, Guangzhou (CN); Ruibin CHEN, Guangzhou (CN); Xueke SUN, Guangzhou (CN); Min CAO, Guangzhou (CN); Sujun JIANG, Guangzhou (CN); Mingxin LI, Guangzhou (CN)

(21) Appl. No.: 15/286,250

(22) Filed: Oct. 5, 2016

(30) Foreign Application Priority Data
May 12, 2016 (CN) 201610311010.6

(51) Int. Cl. C08G 75/20

(52) U.S. Cl. CPC C08G 75/20

(57) ABSTRACT

A sulfone polymer composition and preparation method thereof, and thermoplastic molding composition therefrom, comprising: (A) at least one aromatic sulfone polymer; (B) one compound of 4,4′-dichlorodiphenyl sulfone; wherein, based on the total weight of the sulfone polymer composition, 4,4′-dichlorodiphenyl sulfone weight content is less than 600 ppm. In the preparation method, tetramethylene sulfone is used as a solvent, 4,4′-dichlorodiphenyl sulfone and 4,4′-Dihydroxydiphenyl sulfone or 4,4′-dihydroxy biphenyl are used as reactive monomers, while the mixed salt of sodium carbonate and potassium carbonate is used as salt-forming agent, the composition may be obtained by polymerization with solution polymerization techniques; wherein the molar ratio of the said potassium carbonate and sodium carbonate is 0.1: 100-5: 100. The sulfone polymer composition has a transmittance greater than 85%, a haze less than 4%, and a yellowness index less than 5, enjoying a significantly improved transparency and color levels.

### TECHNICAL FIELD

The present invention relates to the technical field of polymer materials, in particular to a sulfone polymer composition and preparation method thereof and the thermoplastic molding composition therefrom.

### BACKGROUND TECHNIQUE

Belonging to special high-temperature transparent engineering thermoplastics, sulfone polymer has outstanding thermal performance, excellent chemical resistance, excellent high-temperature creep resistance, excellent dimensional stability, low smoke and toxic gas emission, excellent heat water and superheated steam resistance, good electrical properties, including maily three types, i.e. polysulfone (PSU), polyethersulfone (PES) and polyphenyl sulfone (PPSU). It has already experienced 50 years of development from the 1970s to now. As the maturing sulfone polymer materials are developing with gradual perfection, its application range is becoming increasingly wider. Now it has mature applications in food health, medical equipment, household appliances, aerospace, electronic appliances and other fields, especially in terms of food contact products such as baby bottles, non-stick coating, coffee maker accessories, and so. Because of its transparency and heat resistance, it has been applied outstandingly in recent years. Therefore higher requirements has applied on the materials, including transparency, color, content of small molecules and so, and it has also become one of the hot points of research and development.

The method to improve PES color disclosed by Patent publication US6593445 is through control of a single salt-forming agent K₂CO₃ particle size in the range 10-100 μm to acquire light-colored polyether sulfone product, but the impact of its addition and different salt-forming agent and mixed salt-forming agent on the color has not been clearly disclosed. In the method of producing PPSU disclosed by EP2010061924 patent, K₂CO₃ is used as the salt-forming agent, and the PPSU of lower chlorine content with lighter color in achieved by the addition of an aqueous solution of an alkali metal hydroxide to control chlorine content of of to groups at the polymer end at the late stage in the polymerization, but it has not researched into the impact of different salt-forming agents on the degree of completion of the reaction and the impact of the content of residual monomers on the color and transparency. U.S. Pat. No. 4,176,222 disclosed the sulfone polymers preparation method and its reactivity based on mixed salts, i.e. 0.1 to 20 mol of cesium salt or 0.05 to 10 mol of potassium salt was added into per 100 mol of of sodium salt. The mixed salts used in this patent is to increase the reaction rate to get the polymer of high molecular weight. The higher the reactivity, the more easy to form a gel. And it did not cover the reaction completeness and influence of the content of residual monomers on the color and transparency.

The present inventor has surprisingly found that the content of 4,4′-dichlorodiphenyl sulfone in the sulfone polymer composition has a significant impact on the transparency and color of the resin. In the present invention,when the weight content of 4,4′-dichlorodiphenyl sulfone in the sulfone polymer composition is controlled at less than 600 ppm, the transmittance of sulfone polymer composition will be greater than 85%, with a haze less than 4%, a yellowness index less than 5, it can significantly improve the transparency and color of sulfone polymer composition.

### SUMMARY OF THE INVENTION

The purpose of the present invention is to provide a sulfone polymer composition with a 4,4′-dichlorodiphenyl sulfone content less than 600 ppm, and the composition has remarkably improved transparency and color levels.

Another purpose of the present invention is to provide a preparation method for the sulfone polymer composition.

The present invention is realized by the following technical solutions:
A sulfone polymer composition comprising:
   (A) an aromatic sulfone polymer;
   (B) 4,4′- dichlorodiphenyl sulfone;

Wherein, based on the total weight of the sulfone polymer composition, the weight content of the 4,4′-dichlorodiphenyl sulfone is less than 600 ppm.

Preferably, based on the total weight of the sulfone polymer composition, the weight content of the 4,4′-dichlorodiphenyl sulfone is less than 400 ppm, more preferably less than 300 ppm.

The said aromatic sulfone polymer is polyethersulfone (PES), polyphenyl sulfone (PPSU), or mixtures thereof.

Based on research, the present invention found that the content of 4,4′-dichlorodiphenyl sulfone in the sulfone polymer composition has a significant impact on the transparency and color of the resin. The present inventor has surprisingly found that when the weight content of 4,4′-dichlorodiphenyl sulfone in the sulfone polymer composition is controlled at less than 600 ppm, the transmittance of sulfone polymer composition will be greater than 85%, with a haze less than 4%, a yellowness index less than 5, the sulfone polymer composition has significantly improved transparency and color.

The invention provides a preparation method for the sulfone polymer composition, comprising the following steps: tetramethylene sulfone is used as a solvent, 4,4′-dichlorodiphenyl sulfone and 4,4′-dihydroxydiphenyl sulfone or 4,4′-dihydroxy biphenyl are used as reactive monomers, while the mixed salt of sodium carbonate and potassium carbonate is used as salt-forming agent, the composition of the present invention may be obtained by polymerization with solution polymerization techniques; wherein when 4,4′-dichlorodiphenyl sulfone and 4,4′-dihydroxydiphenyl sulfone are used as reactive monomers, the polymer obtained will be PES and the molar ratio of the said potassium carbonate and sodium carbonate is 0.1: 100-3: 100; when 4,4′-dichlorodiphenyl sulfone and 4,4′-dihydroxy biphenyl are used as reactive monomers, the polymer obtained will be PPSU and the molar ratio of the said potassium carbonate and sodium carbonate is 0.1: 100-5: 100.

In the present invention, a mixture of sodium carbonate and trace potassium carbonate is used as a salt-forming agent to be added to the polymerization system. First, a hydroxyl group on a bisphenol monomer is substituted by a phenol salt group, i.e. NaO- and KO- in a neucleophilic substitution reaction, then it reacts with another halogen-containing monomer (4,4-dichlorodiphenyl sulfone) to produce metal halide (NaCl and KCl). Because the activity of K+ is higher than that of Na+, K+ will re-engage the affinity substitution reaction, so that even trace amount of K+ can increase the reaction rate overall for it participates in the reaction in a circulation way, so that the monomers can more fully participate in the polymerization. Conversely, if the content of K+ is too high, there will be a large number of reactive end groups participating in the reaction to form a crosslinked gel and other side reactions will occur, such as U.S. Pat. No. 4,176,222, while avoiding hydrolysis of monomers, such as CN201310018193, therefore, controlling the content of K+ is particularly important. In the present invention, the molar ratio of potassium carbonate over sodium carbonate is controlled in the range of 0.1: 100-5: 100, so that the sulfone polymers prepared has not only the straight chain molecular structure corresponding to the existing single salt forming agent technology, but also a higher reaction rate of synthesis process, shortening the polymerization time. The most prominent feature of the technology is enable to improve the reactivity during the synthesis, thereby enabling the monomer to participate more fully in the reaction, significantly reducing unreacted monomer content, thereby significantly improving transparency and color of sulfone polymer composition.

The present invention also provides a thermoplastic molding composition, comprising the above sulfone polymer composition.

The molding composition of the present invention may contain fillers, especially fibers, particularly preferably glass fibers. In the thermoplastic molding compositions of the present invention, there may be any glass fibers known to the skilled person in this field and suitable for thermoplastic molding composition.

The molding composition of the present invention may contain other components as auxiliaries, in particular a mixture of processing aids, pigments, stabilizers, flame retardants, or different additives. Examples of other conventional additive substances are antioxidants, heat stabilizers, UV stabilizers, lubricants and mold release agents and pigments.

The antioxidants and heat stabilizers used may be hindered phenols, hydroquinone, substituted forms of the said groups, an aromatic secondary amine or phosphite or phosphonite compounds, or may also be combination of them optionally with phosphorus-containing acids, or a salt thereof, or a mixture of said compounds.

Examples of UV stabilizers are various substituted resorcinols, salicylates, benzotriazoles and benzophenones,

Lubricants and mold release agents may be stearyl alcohol, stearic acid alkyl esters, stearic acid amide, and esters of pentaerythritol with long-chain fatty acid, and may also be dialkyl ketones, e.g., distearyl.

The pigments may be white pigments such as zinc oxide, zinc sulfide, white lead, lithopone, antimony white and titanium dioxide. They may also be black pigments according to the present invention such as black iron oxide, spinel black, manganese black, cobalt black and antimony black, and carbon black.

The thermoplastic molding composition of the present invention can be prepared in a method known to the public, such as extrusion. The molding composition of the present invention may be prepared, for example, by mixing the starting components in a conventional mixing apparatus, e.g., based on a screw extruder, preferably a twin screw extruder.

Compared with the prior art, the present invention has the following advantageous effects:

(1) sulfone polymer composition of the present invention contains less than 600ppm by weight of the content of 4,4′-dichlorodiphenyl sulfone compound, the transmittance of the sulfone polymer composition is greater than 85%, with a haze of less than 4%, a yellowness index of less than 5, having significantly improved transparency and color levels.

(2) In the preparation process of the present invention, the mixed salt of sodium carbonate and traces of potassium carbonate is as a salt-forming agent, which can improve the reactivity during the synthesis, thereby enabling the monomer to participate in the reaction more fully, shorten the polymerization time, significantly reduce the content of the unreacted monomers, thereby significantly improving the transparency and color of the sulfone polymer composition, while strictly defining proportions of active ingredients in the salt-forming agent, thus avoiding the side reactions due to excessive activity.

### DESCRIPTION OF FIGURES

FIG. 1 shows the viscosity growth curve of sulfone polymer prepared with salt forming agent of mixed salts in embodiment Example 1;

FIG. 2 shows the viscosity growth curve of sulfone polymer prepared with single salt forming agent in comparative Example 1;

FIG. 3 is a headspace GC-MS spectra of sulfone polymer prepared with salt forming agent of mixed salts in embodiment Example 1, wherein the mass spectral peak at 12.3min position is the residual monomer 4,4-dichlorodiphenyl sulfone;

FIG. 4 is a headspace GC-MS spectra of sulfone polymer prepared with single salt forming agent in comparative Example 1, wherein the mass spectral peak at 12.3min position is the residual monomer 4,4-dichlorodiphenyl sulfone.

### EMBODIMENTS

The following specific embodiments further illustrate the present invention, the following examples are preferred embodiments of the present invention, but the embodiment of the present invention is not limited to those described below.

Testing Methods:

transmittance and haze: result of the test on a injection molding plate with a thickness of 2 mm according to ASTM D1003-07 (%).

Yellowness index: yellowness index obtained in the test on a injection molding plate with a thickness of 2 mm according to ASTM D1925 (YI).

Polymer melt viscosity growth: the melt viscosity may be monitored in a real-time way with a German MARIMEX company's VS-4450 on-line viscometer.

The weight content of 4,4′-dichlorodiphenyl sulfone is determined by headspace gas chromatography and mass spectrometry: with an American CDS8000 Dynamic Headspace Sampler concentrator headspace device, enclosing traps filled with Tenax-GC adsorbing organic fillers, put 0.2 g of polymer to be tested into the headspace sampling chamber for one hour at 300° C., test the gas collected gas with Agilent's 7890B-5977A MSD type GC-MS monitoring equipment; chromatographic conditions: capillary column of HP-5MS (30m×250 μm, 0.25 m); temperature rises to 390° C. with a speed of 15° C./min, inlet temperature of 390° C., the carrier gas is He gas with flow rate of 0.8 mL / min, split ratio 50: 1; mass spectrum conditions of El source, the ionization voltage of 70 eV, ion source temperature of 250° C., scanning range: 30-600 m/z. Internal standard method can be used to acquire the standard curve to quantify the content of the 4,4′-dichlorodiphenyl sulfone monomer.

### EXAMPLE 1

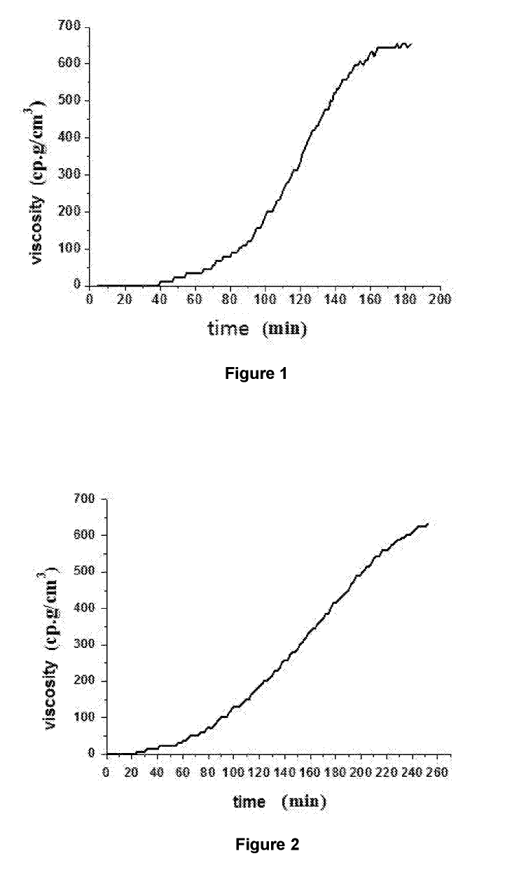

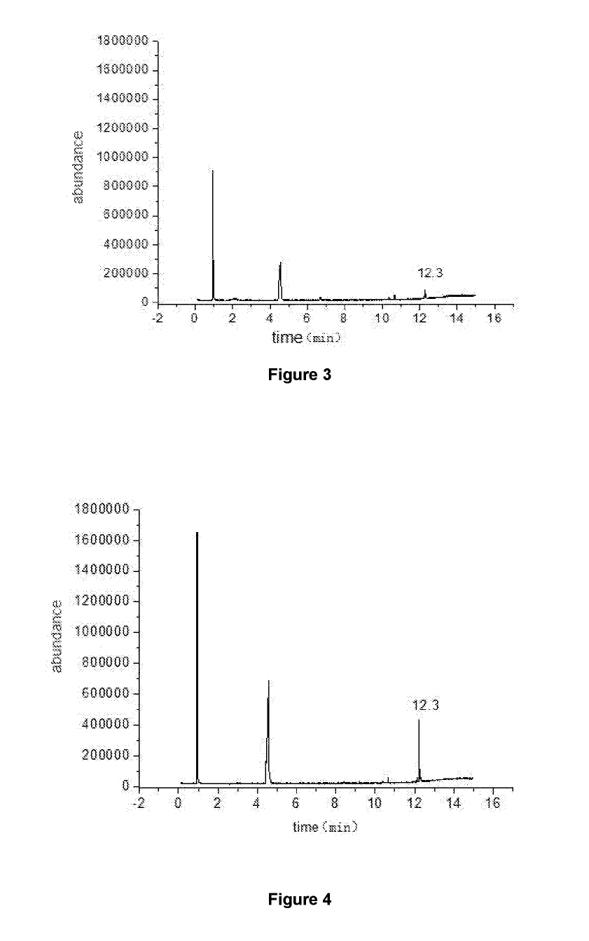

Add sequentially 7.508 kg (30 mol) of 4,4′-dihydroxydiphenyl sulfone, 8.787 kg (30.6 mol) of 4,4′-dichlorodiphenyl sulfone into the 50L polymerization reactor equipped with a thermometer, a nitrogen-introducing tube, condensate trap, and a stirrer, then add to it 32.62 kg of tetramethylene sulfone, stir it and heat it to 100° C. to dissolve the monomer solution until transparency, and 3.396kg (32.039 mol) of salt-forming agent Na₂CO₃ and 132.6 g (0.961 mol) of salt-forming agent K₂CO₃, followed by addition of 2L of xylene, and heat it to start the salt forming reaction while stirring it continuously. The azeotrope forming from the water produced in the system and xylene is blown by the protective gas to the condensation tube, condensed therein and drops into water trap and layers there, the upper layer of xylene refluxes to the system; maintain a temperature range of 200° C. -210° C., when water amount collected is close to the theoretical value (540 g), let the reflux continue for 20 minutes, no water droplets falling being found indicating completion of the salt forming reaction. Distill it again and drain the xylene, and gradually heat it to 230° C. to start the polymerization reaction, and the viscosity detected starts to increase at this time. Keep it at constant temperature for 2.5 hours, the slope of viscosity growth curve is substantially zero, the viscosity growth curve is shown in FIG. 1. When the viscosity of the system becomes completely constant, the reaction will end; stop stirring and heating, pour the material slowly into deionized water and cool it into white striped solid, and then crush it into a powder with a pulverizer. Boil it with deionized water for 1 hour, filter it to remove the water, repeat so for 10 times, until the filtrate not becoming turbid when tested with silver nitrate, indicating that the powder byproduct salt has been washed clean. After filtration, put the polymer in a vacuum oven with 120° C. and dry it to constant weight and that is the product polyethersulfone (PES); the weight content of 4,4′- dichlorodiphenyl sulfone is determined by headspace gas chromatography—mass spectrometry, the detection chromatogram is shown in FIG. 3, the peak position appears in 12.8min position is mass spectrometry peak of the monomer 4,4′-dichlorodiphenyl sulfone. The test results of transmittance, yellowness index, haze and other performance indicators of the prepared sulfone polymer composition are shown in Table 1.

### EXAMPLE 2

Based on Example 1, wherein except that then add to it 3.446kg (32.512 mol) of salt -forming agent Na₂CO₃ and 67.4 g (0.488 mol) of salt-forming agent K₂CO₃, while the remaining is the same as in Example 1. Keep it at constant temperature for 3 hours to achieve completely constant system viscosity. After drying the polymer, the product obtained is polyethersulfone (PES), performance test results are shown in Table 1.

### EXAMPLE 3

Based on Example 1, wherein except that then add to it 3.412 kg (32.195 mol) of salt-forming agent Na₂CO₃ and 111.242 g (0.805 mol) of salt-forming agent K₂CO₃, while the remaining is the same as in Example 1. Keep it at constant temperature for 3.5 hours to achieve completely constant system viscosity. After drying the polymer, the product obtained is polyethersulfone (PES), performance test results are shown in Table 1.

### EXAMPLE 4

Based on Example 1, wherein except that then add to it 3.429 kg (32.353 mol) of salt-forming agent Na₂CO₃ and 89.294 g (0.6470 mol) of salt-forming agent K₂CO₃, while the remaining is the same as in Example 1. Keep it at constant temperature for 3.5 hours to achieve completely constant system viscosity. After drying the polymer, the product obtained is polyethersulfone (PES), performance test results are shown in Table 1.

### EXAMPLE 5

Based on Example 1, wherein except that add to it3.463 kg (32.673 mol) of salt- forming agent Na₂CO₃ and 45.158 g (0.327 mol) of salt-forming agent K₂CO₃, while the remaining is the same as in Example 1. Keep it at constant temperature for 3.5 hours to achieve completely constant system viscosity. After drying the polymer, the product obtained is polyethersulfone (PES), performance test results are shown in Table 1.

### EXAMPLE 6

Based on Example 1, wherein except that then add to it 3.470 kg (32.738 mol) of salt-forming agent Na₂CO₃ and 36.198 g (0.262 mol) of salt-forming agent K₂CO₃, while the remaining is the same as in Example 1. Keep it at constant temperature for 3.5 hours to achieve completely constant system viscosity. After drying the polymer, the product obtained is polyethersulfone (PES), performance test results are shown in Table 1.

### EXAMPLE 7

Based on Example 1, wherein except that then add to it 3.480 kg (32.836 mol) of salt-forming agent Na₂CO₃ and 22.69 g (0.164 mol) of salt-forming agent K₂CO₃, while the remaining is the same as in Example 1. Keep it at constant temperature for 3.5 hours to achieve completely constant system viscosity. After drying the polymer, the product obtained is polyethersulfone (PES), performance test results are shown in Table 1.

### EXAMPLE 8

Based on Example 1, wherein except that then add to it 3.494 kg (32.967 mol) of salt-forming agent Na₂CO₃ and 4.56 g (0.0329 mol) of salt-forming agent K₂CO₃, while the remaining is the same as in Example 1. Keep it at constant temperature for 3.5 hours to achieve completely constant system viscosity. After drying the polymer, the product obtained is polyethersulfone (PES), performance test results are shown in Table 1.

### EXAMPLE 9

Based on Example 1, wherein except that add sequentially 5.586 kg (30 mol) of 4,4′-dihydroxybiphenyl sulfone , 8.787 kg (30.6 mol) of 4,4′- dichlorodiphenyl sulfone into the 50L polymerization reactor equipped with a thermometer, a nitrogen-introducing tube, condensate trap, and a stirrer, then add to it 28.14 kg of tetramethylene sulfone, stir it and heat it to dissolve, and then add to it 3.331 kg (31.428 mol) of salt-forming agent Na₂CO₃ and 0.217 kg (1.571 mol) of salt- forming agent K₂CO₃, while the remaining is the same as in Example 1. Keep it at constant temperature for 3 hours to achieve completely constant system viscosity. After drying the polymer, the product obtained is polyphenyl sulfone (PPSU), performance test results are shown in Table 1.

### EXAMPLE 10

Based on Example 9, wherein except that then add to it 3.429 kg (32.353 mol) of salt-forming agent Na₂CO₃ and 893 g (0.647 mol) of salt-forming agent K₂CO₃, while the remaining is the same as in Example 9. Keep it at constant temperature for 3.5 hours to achieve completely constant system viscosity. After drying the polymer, the product obtained is polyphenyl sulfone (PPSU), performance test results are shown in Table 1.

### EXAMPLE 11

Based on Example 9, wherein except that then add to it 3.495 kg (32.967 mol) of salt- forming agent Na₂CO₃ and 4.55 g (0.0329 mol) of salt-forming agent K₂CO₃, while the remaining is the same as in Example 9. Keep it at constant temperature for 4 hours to achieve completely constant system viscosity. After drying the polymer, the product obtained is polyphenyl sulfone (PPSU), performance test results are shown in Table 1.

### COMPARATIVE EXAMPLE 1

Based on Example 1, wherein except that then add to it 3.498 kg (33 mol) of salt- forming agent Na₂CO₃, while the remaining is the same as in Example 1. Keep it at constant temperature for 4 hours, the slope of the viscosity growth curve shows a trend of slowing down, the viscosity growth curve is shown in FIG. 2, indicating that the viscosity has a constant tendency, and end the reaction. After drying the polymer, the product obtained is polyether sulfone (PES). The weight content of 4,4′-dichlorodiphenyl sulfone is determined by headspace gas chromatography—mass spectrometry, the detection chromatogram is shown in FIG. 4, the peak appears in 12.8 min position is MS peak of the monomer 4,4′-dichlorodiphenyl sulfone. The test results of performance are shown in Table 1.

### COMPARATIVE EXAMPLE 2

Based on Example 9, wherein except that then add to it 3.498 kg (33 mol) of salt- forming agent Na₂CO₃, while the remaining is the same as in Example 9. Keep it at constant temperature for 4.5 hours, the system viscosity shows a constant trend, and end the reaction. After drying the polymer, the product obtained is polyphenyl sulfone (PPSU). The test results of performance are shown in Table 1.

### COMPARATIVE EXAMPLE 3

Based on Example 1, wherein except that then add to it 3.496 kg (32.984 mol) of salt -forming agent Na₂CO₃ and 2.28 g (0.0165 mol) of salt-forming agent K₂CO₃, keep it at constant temperature for 4.5 hours while the remaining is the same as in Example 1. After drying the polymer, the product obtained is polyethersulfone (PES), performance test results are shown in Table 1.

### COMPARATIVE EXAMPLE 4

Based on Example 1, wherein except that then add to it 3.180 kg (33.0 mol of salt-forming agent Na₂CO₃ and 414.63 g (3 mol) of salt-forming agent K₂CO₃, keep it at constant temperature for 2.5 hours while the remaining is the same as in Example 1. After drying the polymer, the product obtained is polyethersulfone (PES), performance test results are shown in Table 1.

TABLE 1
Performance test results of sulfone polymer composition in
embodiment examples and comparative examples

| | comp. | comp. | comp. | comp. | | | | |
|---|---|---|---|---|---|---|---|---|
| | exmp. 1 | exmp. 2 | exmp. 3 | exmp. 4 | example 1 | example 2 | example 3 | example 4 |
| K₂CO₃:Na₂CO₃ (mol ratio) | 0:100 | 0:100 | 0.05:100 | 10:100 | 3:100 | 1.5:100 | 2.5:100 | 2:100 |
| Melt viscosity/cP · g/cm3 | 298 | 578 | 311 | 488 | 323 | 350 | 344 | 341 |
| 4,4′-dichlorodiphenyl | 988 | 879 | 949 | 1078 | 229 | 155 | 285 | 328 |
| sulfone content/ppm | | | | | | | | |
| Transmittance/% | 77.6 | 75.8 | 75.3 | 71.2 | 88.4 | 87.5 | 88.5 | 86.1 |
| Yellowness index | 14.65 | 15.54 | 15.11 | 13.24 | 2.56 | 2.76 | 2.67 | 3.27 |
| Haze/% | 8.56 | 7.07 | 7.58 | 8.42 | 2.45 | 2.13 | 2.85 | 3.25 |

| | | | | | | example | example |
|---|---|---|---|---|---|---|---|
| | example 5 | example 6 | example 7 | example 8 | example 9 | 10 | 11 |
| K₂CO₃:Na₂CO₃ (mol ratio) | 1:100 | 0.8:100 | 0.5:100 | 0.1:100 | 5:100 | 2:100 | 0.1:100 |
| Melt viscosity/cP · g/cm3 | 372 | 387 | 399 | 413 | 633 | 655 | 643 |
| 4,4′-dichlorodiphenyl | 389 | 438 | 496 | 586 | 189 | 387 | 405 |
| sulfone content/ppm | | | | | | | |
| Transmittance/% | 86.4 | 85.1 | 85.9 | 85.5 | 87.2 | 86.5 | 85.1 |
| Yellowness index | 3.29 | 3.33 | 4.68 | 4.89 | 3.84 | 4.76 | 4.87 |
| Haze/% | 3.07 | 3.74 | 3.65 | 3.92 | 3.26 | 3.57 | 3.75 |

1. A sulfone polymer composition, comprising:
(A) an aromatic sulfone polymer; and
(B) 4,4′- dichlorodiphenyl sulfone;
wherein based on the total weight of the sulfone polymer composition, the weight content of the 4,4′-dichlorodiphenyl sulfone is less than 600 ppm.

2. The sulfone polymer composition according to claim 1, wherein the weight content of the said 4,4-dichlorodiphenyl sulfone is determined by headspace gas chromatography-mass spectrometry with an American CDS8000 Dynamic Headspace Concentrator headspace device having a headspace sampling chamber, enclosing traps filled with Tenax-GC organic adsorbing fillers, putting 0.2 g sulfone polymer composition to be tested into the headspace sampling chamber for one hour at 300° C., and testing the gas collected with Agilent's 7890B-5977A MSD type GC-MS monitoring equipment under chromatographic conditions of a capillary column of HP-5 MS, 30 m×250 μm, 0.25 m, wherein the temperature rises to 390° C. with the speed of 15° C./ min, the sample inlet temperature is 390° C., the carrier gas is He gas with a flow rate of 0.8 mL/min, with a split ratio of 50: 1 and MS conditions of EI source, ionizing voltage of 70 eV, ion source temperature of 250° C., and a scan range of 30-600 m/z.

3. The sulfone polymer composition according to claim 1, wherein based on the total weight of the sulfone polymer composition, the weight content of 4,4′-dichlorodiphenyl sulfone is less than 400 ppm.

4. The sulfone polymer composition according to claim 3, wherein based on the total weight of the sulfone polymer composition, the weight content of 4,4′-dichlorodiphenyl sulfone is less than 300 ppm.

5. The sulfone polymer composition according to claim 1, wherein the said sulfone polymer composition has a transmittance of greater than 85% and a haze of less than 4% obtained at the test made on an injection plastic plate with a thickness of 2 mm in accordance with ASTM D1003-07.

6. The sulfone polymer composition according to claim 1, wherein the said sulfone polymer composition has a Yellowness Index of less than 5 obtained at the test made on an injection plastic plate with a thickness of 2 mm in accordance with ASTM D1925.

7. The sulfone polymer composition according to claim 1, wherein the aromatic sulfone polymer is polyethersulfone, polyphenyl sulfone or mixtures thereof.

8. A preparation method for the sulfone polymer composition according to claim 1 comprising the following steps:
using tetramethylene sulfone as a solvent,
using 4,4′-dichlorodiphenyl sulfone and 4,4′-dihydroxydiphenyl sulfone or 4,4′-dihydroxybiphenyl as reactive monomers,
using a mixed salt of sodium carbonate and potassium carbonate as a salt-forming agent, wherein the composition is obtained by polymerization with solution polymerization techniques, wherein when 4,4′-dichlorodiphenyl sulfone and 4,4′-dihydroxydiphenyl sulfone are used as reactive monomers, the polymer obtained will be polyethersulfone (PES) and the molar ratio of the said potassium carbonate and sodium carbonate is 0.1:100-3:100, and wherein when 4,4′-dichlorodiphenyl sulfone and 4,4′-dihydroxy biphenyl are used as reactive monomers, the polymer obtained will be polyphenyl sulfone (PPSU) and the molar ratio of the said potassium carbonate and sodium carbonate is 0.1:100-5:100.

9. A thermoplastic molding composition, comprising the sulfone polymer composition according to claim 1.
